(19) United States
(12) Patent Application Publication
(10) Pub. No.: US 2017/0184222 A1
(43) Pub. Date: Jun. 29, 2017

(54) Pipe Suspension Clamp Hanger

(71) Applicant: Seth E. Aker, Robertsdale, AL (US)

(72) Inventor: Seth E. Aker, Robertsdale, AL (US)

(21) Appl. No.: 14/981,882

(22) Filed: Dec. 28, 2015

(51) Int. Cl. F16L 3/10; F16L 3/14

(52) U.S. Cl. CPC F16L 3/1075; F16L 3/14

(57) ABSTRACT

A hanger for supporting a pipe, which comprises a split ring structure for receiving the pipe, a threaded rod to receive a circular clamp, an adapting mechanism for coupling a pair of c-shaped arms of the split ring structure and a plurality of nuts for adapting the split ring structure. Further, the split ring structure is configured to form a c-shaped saddle support strap by the plurality of nuts.

### CROSS REFERENCE TO RELATED APPLICATIONS

Not applicable.

### FEDERALLY SPONSORED RESEARCH & DEVELOPMENT

Not applicable.

### MICROFICHE APPENDIX

Not applicable.

### BACKGROUND OF THE INVENTION

(1) Field of the Invention

The invention generally relates to a method and system for pipe hangers. More particularly, it relates to an improved way of retaining a pipe and liner within the hanger.

(2) Background of the Invention

Residential and commercial buildings invariably include networks of piping ranging from plumbing pipes to electrical conduits. While piping in these buildings is sometimes supported by a floor or underlying support structure, many piping layouts require that the piping be suspended, for example, by securing the piping to adjacent support structures, such as beams, floor joists, ceiling joists, rafters, etc. Typically, this is accomplished by utilizing pipe hangers. Pipe hangers generally extend around a portion of the pipe and attach, by some means, to a support structure.

Cast iron pipe, one time in widespread use, was typically suspended by means of “plumbers tape”, a flexible metal strip that cradles the pipe and is nailed to overhead structural elements through pre-drilled holes in the tape. Because plastic pipe has substantially replaced the use of cast iron pipe, more rigid hanger devices have been devised to prevent the lighter and more flexible plastic pipe from “floating” as the pipe is subjected to the external or internal temperature changes. One such device is illustrated in U.S. Pat. No. 3,273,837, issued Sep. 20, 1966, to C. C. Wallert, et al., which discloses a pipe hanger that rigidly holds plastic drain pipes in a fixed position. The Willert patent also discusses an additional general requirement for supporting plastic pipe: requiring more closely spaced support elements to avoid sagging.

Pipe hangers of various kinds are well known in the art. Examples of such hangers are shown in U.S. Pat. No. 4,413,799, to Gabriel, and U.S. Pat. No. 5,344,108, to Heath. Such hangers typically include a strap-like member bent into a loop or stirrup-like configuration with the ends of the strap overlapping. The pipe rests within the loop. A threaded rod or similar device extends through the overlapping ends. A nut or other fastener or retaining device may be attached to the rod to secure the rod to the loop. The other end of the rod is secured to the surface from which the pipe is to be suspended. With this arrangement, a gap typically exists between the overlapping ends of the strap and the pipe. One end of the rod and the nut are located in this gap such that there is space between the end of the rod and the pipe.

As an inspection of U.S. Pat. No. 3,517,901 will show, the side-load type hanger is characterized by a generally C-shaped saddle portion in which a pipe section is received. The saddle is welded to one end of a support leg. The support leg is connected to a support structure at its other end. The pipe section, surrounded by a liner, is positioned within the interior of the saddle.

There are drawbacks and shortcomings to conventional pipe hangers. They are often difficult to use. In fact, they are so difficult to use that suspending pipes and pipe networks in a building can be time consuming and costly. In addition, many conventional pipe hangers are inflexible, that is they have to be used in a certain way and do not give the installer a great deal of latitude when it comes to installing pipes and networks of pipes in unusual situations. Furthermore, some pipe hangers lack sufficient strength to adequately support certain spans of piping. In other cases, conventional pipe hangers tend to deteriorate and rust under certain conditions. Finally, many types of pipe hangers are expensive to make, and this translates into an expensive product.

Therefore, there has been and continues to be a need for a highly flexible and easy to use pipe hanger that can be manufactured in a cost effective manner.

SUMMARY OF THE INVENTION

In accordance with one embodiment of the present invention, a split ring structure hanger is provided. It is, therefore, an objective of the present invention to provide a split pipe hanger particularly adapted for use in residential or commercial plumbing hardware.

In accordance with another embodiment, a system for securing multiple hangers on one all-threaded rod is provided. In its preferred construction, the diameter of the all-threaded rodis ⅜″.

In a particularly preferred embodiment, the split ring hanger is casted from galvanized metal and copper-coated metal. It is contemplated that the split pipe hanger of the invention will be designed to hold pipes ranging in diameter from ½″ to 2″, though it will be readily understood that the invention could be made to accommodate pipe sizes outside of this range.

Even more preferred is an embodiment of the invention in which the invention cuts down material costs and labor costs.

Using the split pipe hanger of the invention, any one of several standard pipe sizes or fitting sizes can be secured by simply threading a detached pipe strap through the pipe stabilizing element of the invention and around the pipe, and then mechanically securing the tail end of the pipe strap. The hanger rod is attached at its free end to an overhead structural element. An alternative means of attaching the hanger rod might be to provide pre-drilled holes in the top of the rod to accommodate wood screws. It is a further objective of the invention to provide an adjustable pipe hanger that will securely hold a length of plastic pipe in a vertical elevation so as to maintain the grade of the pipe, and to to restrain lateral movement of the pipe. This could be used in the field of DWX, PEX, CPVC, PVC pipes.

Other features and advantages of the present invention will become more apparent from the following detailed description when taken in conjunction with the accompanying drawings, which illustrate, by way of example, the principles of the invention.

### BRIEF DESCRIPTION OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention, and is, therefore, not to be considered limiting of its scope. The invention will be described and explained with additional specificity and detail through the use of the accompanying drawing, in which:

FIG. 1 is a diagram illustrating the improved top plan view of the pipe-stabilizing element of the split pipe hanger in accordance with an embodiment of the present invention.

### DETAIL DESCRIPTION OF THE INVENTION

The following detailed description refers to the accompanying drawings that illustrate the embodiments of the present invention. Other embodiments are possible, and modifications may be made to the embodiments without departing from the spirit and scope of the invention. Therefore, the following detailed description is not meant to limit the invention. Rather, the scope of the invention is defined by the appended claims.

A pipe supportive device or pipe hanger is a designed assembly that carries the load of the pipe to the supporting structures. The load includes the weight of pipe proper, the content the pipe carries, all of the pipe fittings attached to the pipe, and the pipe covering, such as insulation. Some other types of pipe hangers could carry multiple pipes at a time that are using in plumbing supply chain and for hardware.

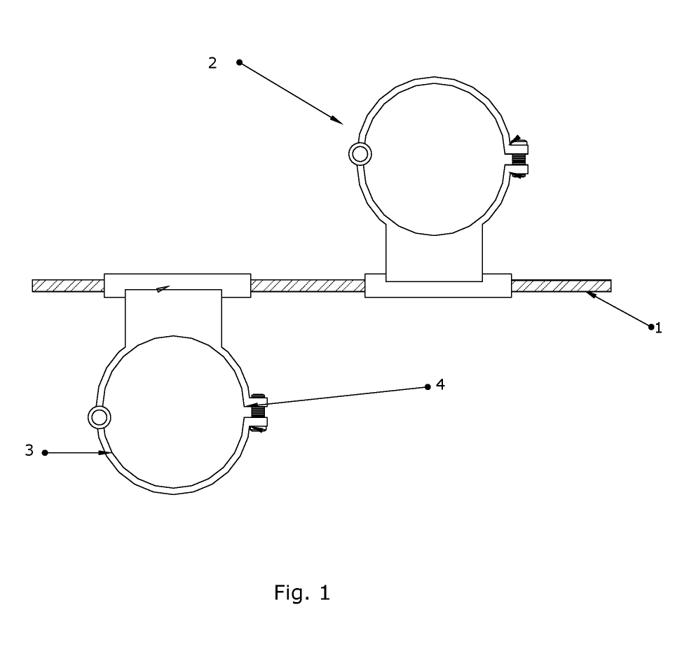

A suspensory securing device for piping shall now be described, in accordance with FIG. 1.

Referring now to the drawings for the purposes of illustrating embodiments of the invention, and not for the purposes of limiting the same, FIG. 1 illustrates one embodiment of the present invention.

The pipe support system or pipe hanger is comprised of a threaded rod (1), which, in the case of this embodiment, is a galvanized and metal coated member. The galvanized and metal coated member is connected to a pipe hanger or C-shaped saddle, indicated generally by the numerals (2) and (3). The threaded rod (1) is, but not limited to, having a diameter of ⅜ inches. The pipe hanger is connected to the connector and forms a loop. A pipe or pipe segment is projected into the loop. As seen in FIG. 1, the pipe hanger extends at least partially around the pipe and supports the pipe. As will be appreciated from subsequent portions of this disclosure, the opposite ends of the pipe hanger include one or more spikes that are driven or projected into the thread rod. The C-shaped saddle has a pair of arms, as hereinafter described to secure a length of pipe.

The pipe hanger also includes a plurality of nuts (4) for coupling the pair of arms which are C-shaped saddle. The tightening of the C-shaped saddle (2) with the help of a nut (4) facilitates the proper securing of the pipe in the saddle's loop (3).

From the above discussion, it is clear that the present invention provides a pipe hanger that can be placed in position at any residential and commercial works. Additionally, the present invention provides a means for attaching the multiple pipes in a split pipe hanger to the threaded rod while preventing displacement of the hanger and, thereby, bending the pipe supported by the hangers. The present invention also provides a pipe hanger that allows a fully developed load carrying hanger of great structural integrity to support the pipe during repairs of the foundation and after a pour has been completed.

It is to be understood that the above description is intended to be illustrative, and not restrictive. For example, the above-discussed embodiments may be used in combination with each other. Many other embodiments will be apparent to those of skill in the art upon reviewing the above description. It is to be understood that the above description is intended to be illustrative, and not restrictive. For example, the above-discussed embodiments may be used in combination with each other. Many other embodiments will be apparent to those of skill in the art upon reviewing the above description.

Plural instances may be provided for components, operations, or structures described herein as a single instance. Finally, boundaries between the various components are somewhat arbitrary, and particular operations are illustrated in the context of specific illustrative configurations. Other allocations of functionality are envisioned, and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A hanger for supporting a pipe, the hanger comprising:
a split ring for receiving said pipe, said split ring including a circular clamp at one end;
a threaded rod configured to receive the circular clamp; wherein,
said split ring includes an adapting mechanism for coupling with a pair of C-shaped arms of said split ring, and
said split ring is a single-split ring and is configured to exhibit spring tension to provide elastic support to said pipe.

2. The hanger according to claim 1, wherein said split ring is configured to form a c-shaped saddle support strap by a plurality of fastening members.

3. The hanger according to claim 2, wherein said saddle support structure is configured to hold said pipe in said split ring.

4. The hanger according to claim 1, wherein said threaded rod is configured to provide a secure base for placing said split ring.

5. The hanger according to claim 1, wherein said C-shaped arms are configured to house a fastening member with threading for stiffening of said split ring.

6. The hanger according to claim 1, wherein said threaded rod is welded to said split ring with said circular clamp.

7. The hanger according to claim 5, wherein said plurality of fastening members are configured to provide a snug mechanism to said split ring.

8. The hanger according to claim 1, wherein said adapting mechanism is placed pivotally for coupling said pair of C-shaped arms of said split ring.

9. The hanger according to claim 1, wherein said split ring is made of material selected from group comprising galvanized iron, steel, copper, aluminum and combination thereof.

10. The hanger according to claim 8, wherein said split ring include an oval shaped structure on the circumference and is configured to provide a pivotal coupling to said pair of C-shaped arms when the pair of C-shaped arms are coupled.

11. The banger according to claim 10, wherein the oval shape structure is positioned opposite to a coupling region of the C-shaped arms.

12. The banger according to claim 1, wherein a plurality of split rings are welded on a single threaded rod.

13. A hanger for supporting a plurality of pipes, the hanger comprising:
a plurality of split rings for receiving said plurality of pipes, each of said plurality of split rings including a circular clamp at one end;
a threaded rod configured to receive the circular clamp; wherein,
said split ring further includes an adapting mechanism for coupling with a pair of C-shaped arms of said split ring, and wherein each of said split ring include an oval shaped structure on the circumference and is configured to provide a pivotal coupling to said pair of C-shaped arms when the pair of C-shaped arms are coupled by a fastener to support the pipes.

14. The hanger according to claim 14, wherein said plurality of split rings exhibit spring tension to provide an elastic support to the pipe.

15. The hanger according to claim 5, wherein said fastening member is a nut.
